(19) United States
(12) Patent Application Publication
(10) Pub. No.: US 2022/0132825 A1
(43) Pub. Date: May 5, 2022

(54) DOUBLE-SIDED GLUE TRAP FLY SWATTER

(71) Applicants: Nazir Lamin, Lima, OH (US); Nazir Lamin, II, Lima, OH (US); Rayon Lamin, Lima, OH (US)

(72) Inventors: Nazir Lamin, Lima, OH (US); Nazir Lamin, II, Lima, OH (US); Rayon Lamin, Lima, OH (US)

(21) Appl. No.: 17/517,266

(22) Filed: Nov. 2, 2021

Related U.S. Application Data
(60) Provisional application No. 63/108,917, filed on Nov. 3, 2020.

(51) Int. Cl. A01M 3/02

(52) U.S. Cl. CPC A01M 3/022

(57) ABSTRACT

The present invention relates to a fly swatter device that uses a replaceable double-sided glue trap to catch flies and insects. The fly swatter device features a handle and an integrally-attached swatting head frame. The swatting head frame includes a plurality of strings for accommodating a double-sided glue trap that is used for swatting and/or adhering the flies and insects thereto. The double-sided glue trap can be inserted into the frame through a slot on the frame or by removing the plurality of strings. The device can be waved in the air at a swarm of insects to effectively capture them on the glue trap and the glue trap can be replaced when a multitude of insects and flies are caught on the trap. The fly swatter device includes the combined advantages of a conventional swatter, along with a glue trap to catch the flies and insects.

### CROSS-REFERENCE TO RELATED APPLICATION

The present application claims priority to, and the benefit of, U.S. Provisional Application No. 63/108,917, which was filed on Nov. 3, 2020 and is incorporated herein by reference in its entirety.

### FIELD OF THE INVENTION

The present invention relates generally to the field of fly swatters. More specifically, the present invention relates to an improved fly swatter device that uses an integrated double-sided glue trap to catch flies and insects. The fly swatter device includes the combined advantages of a conventional fly swatter along with a glue trap to catch the flies and insects in mid-air, and also from any surface. The fly swatter device features a handle and an integrally-attached swatting head frame. The swatting head frame includes a plurality of strings for accommodating a double-sided glue trap that is used for swatting and adhering the insects and flies. The device can be waved in the air at a swarm of insects to effectively capture them on the glue trap. The glue trap can be replaced when a multitude of insects and flies are caught on the trap. Accordingly, the present disclosure makes specific reference thereto. Nonetheless, it is to be appreciated that aspects of the present invention are also equally applicable to other like applications, devices and methods of manufacture.

### BACKGROUND

By way of background, fly swatters are an everyday necessity. This is especially true during the summer months. In warmer climates, flies or other flying insects often enter into dwellings and create a nuisance. Fly swatters typically include a handle and a swatting head. In use, conventional fly swatters are flicked in order for the swatting head to kill the insect or fly. Conventional flyswatters cannot catch the flies mid-air and can be unsanitary and frustrating to maintain and clean. Hitting flies with such conventional fly swatters generally leaves behind a mess requiring clean up. Consequently, killing such insects and bugs can be a very messy process when using a traditional apparatus. Further, killed insects and flies are sometimes hard to remove from these fly swatters and also, the flies and insects may fall to the ground after being swatted, subsequently requiring manual retrieval which is both laborious and time-consuming for users.

Electric flyswatters are used by individuals to overcome some of the mentioned issues; however, these electric flyswatters are unsafe for children and pets. The swatting head may give an electric shock to a child or pet who accidentally touches the head while the electric connection is in the on position. Individuals generally forget to turn off the activation button of such electric fly swatters, which then poses a threat to everyone in the home.

Some individuals prefer traditional glue fly traps; however, they are static and are hung or placed at a specific location. Individuals can't trap flies and insects that are present at specific and varied places. Further, such glue traps are unsightly and also pose a threat to children and pets if touched or ingested. Other methods, such as using chemical sprays, are harmful for individuals and may contain poisonous ingredients.

Therefore, there exists a long felt need in the art for a fly swatter apparatus that allows individuals to catch flies and insects mid-air. There is also a long felt need in the art for a fly swatter apparatus that is safe for pets and children. Additionally, there is a long felt need in the art for a fly swatter apparatus that is aesthetically-pleasing. Moreover, there is a long felt need in the art for a fly swatter apparatus that does not provide an electric shock upon touching the swatting head. Furthermore, there is a long felt need in the art for a fly swatter apparatus that does not use any chemicals or electrical zappers. Finally, there is a long felt need in the art for a fly swatter apparatus wherein the flies and insects adhere thereto after killing them, does not create a mess and is easy to maintain.

The subject matter disclosed and claimed herein, in one embodiment thereof, comprises a double-sided glue trap fly swatter apparatus. The double-sided glue trap fly swatter apparatus includes a replaceable double-sided glue trap wherein the insects and flies adhere thereto after being killed. The fly swatter features a handle having an ergonomic grip at a proximal end and an integrally attached swatting head at a distal end. The swatting head includes a plurality of strings to accommodate and mount the replaceable double-sided glue trap therebetween, wherein the plurality of strings is removably attached to both sides of a peripheral boundary of the swatting head. The swatting head and replaceable double-sided glue trap are adapted to swat at and adhere to an insect or a fly thereon. The swatting head can include a slot for sliding on or sliding off the double-sided glue trap between the plurality of strings positioned on opposing sides of the swatting head.

In this manner, the fly swatter apparatus of the present invention accomplishes all of the forgoing objectives and provides users with a handheld fly and insect catching device used for removing swarms of, or individual, mosquitoes, gnats, and other insects from mid-air and from surfaces. The flies and insects adhere to the double-sided glue trap, wherein the glue trap can be replaced after a multitude of insects have been caught. Users can simply wave the tool at a swarm of insects to effectively capture them on the glue trap. The apparatus is safe for both children and pets and can be used similarly to a conventional insect swatter.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a glue trap fly swatter. The glue trap fly swatter includes a replaceable double-sided glue trap for adhering insects and flies thereto. The fly swatter further comprising a handle having an ergonomic grip at a proximal end, and an integrally-attached swatting head at a distal end. The swatting head includes a plurality of strings to accommodate the replaceable double-sided glue trap therebetween, wherein the plurality of strings are removably-attached to both sides of a peripheral boundary of the swatting head, and further wherein the replaceable double-sided glue trap is adapted to swat at and adhere an insect or a fly thereon. The swatting head includes a slot for sliding in, or sliding out, the double-sided glue trap between the plurality of strings positioned on opposing sides of the swatting head.

In yet another embodiment, the swatting head is oval in shape and is designed to support the plurality of strings on both sides thereon and wherein the double-sided glue trap can be slid between the plurality of strings disposed on opposing sides of the swatting head periphery.

In yet another embodiment, the double-sided glue trap is exposed from the spaces created between the plurality of strings. The fly swatter can be swatted at insects wherein the insects adhere to exposed areas of the glue trap.

In yet another embodiment, a fly swatter with an integrated double-sided glue trap is disclosed. The fly swatter includes a handle having an ergonomic grip at a first or proximal end and an integrally attached oval head at a second or distal end. The oval head includes a frame having a plurality of flexible strings disposed on each of the opposing sides of the oval head. One side of the frame including a plurality of flexible strings is configured to be selectively-detached from the oval head to enable inserting and removing of the integrated double-sided glue trap. The frame side can be removed manually or can be removed by pressing a push button disposed on the handle.

In yet another embodiment, the double-sided glue trap is accommodated and mounted by sliding between the two frame sides, each having a plurality of flexible strings.

In yet another embodiment of the present invention, a flyswatter with two double-sided glue traps is disclosed. The flyswatter can include an oval swatting head having two surfaces, wherein a double-sided glue trap can be attached to each of the two surfaces using mechanical fasteners. The double-sided glue traps are adapted to swat at insects and flies and to adhere same thereto.

In yet another embodiment, the flyswatter of the present invention can be waved in the air to catch and adhere various types of insects and flies thereto, such as, fruit flies, fungus gnats, thrips, midges, locust, flies, whiteflies, aphids, moths, and many more flying and non-flying insects.

In all the embodiments, the flyswatter does not need electric components, bug zappers, or chemical sprays.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a glue trap fly swatter of the present invention built in accordance with the disclosed architecture;

FIG. 2 illustrates a perspective view of the one potential embodiment of the glue trap fly swatter of the present invention with integrated glue trap in accordance with the disclosed architecture;

FIG. 3 illustrates a perspective view of another potential embodiment of the glue trap fly swatter of the present invention in accordance with the disclosed architecture; and

FIG. 4 illustrates a perspective view of yet another potential embodiment of the glue trap fly swatter of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a fly swatter apparatus that allows individuals to catch flies and insects mid-air. There is also a long felt need in the art for a fly swatter apparatus that is safe for pets and children. Additionally, there is a long felt need in the art for a fly swatter apparatus that is aesthetically pleasing. Moreover, there is a long felt need in the art for a fly swatter apparatus that does not provide an electric shock upon touching the swatting head. Furthermore, there is a long felt need in the art for a fly swatter apparatus that does not use any chemicals or zappers. Finally, there is a long felt need in the art for a fly swatter apparatus wherein the flies and insects adhere thereto after killing them, does not create a mess, and is easy to maintain.

The present invention, in one exemplary embodiment, includes a novel fly swatter with an integrated double-sided glue trap. The fly swatter includes a handle having an ergonomic grip at a first (proximal) end and an integrally-attached oval head at a second (distal) end. The oval head includes a frame having a plurality of flexible strings disposed on each of the opposing sides of the oval head. On one of the frame sides a plurality of flexible strings is configured to be detached from the oval head for enabling insertion and removal of the integrated double-sided glue trap, wherein the frame side can be removed manually or can be removed by pressing a push button disposed on the handle.

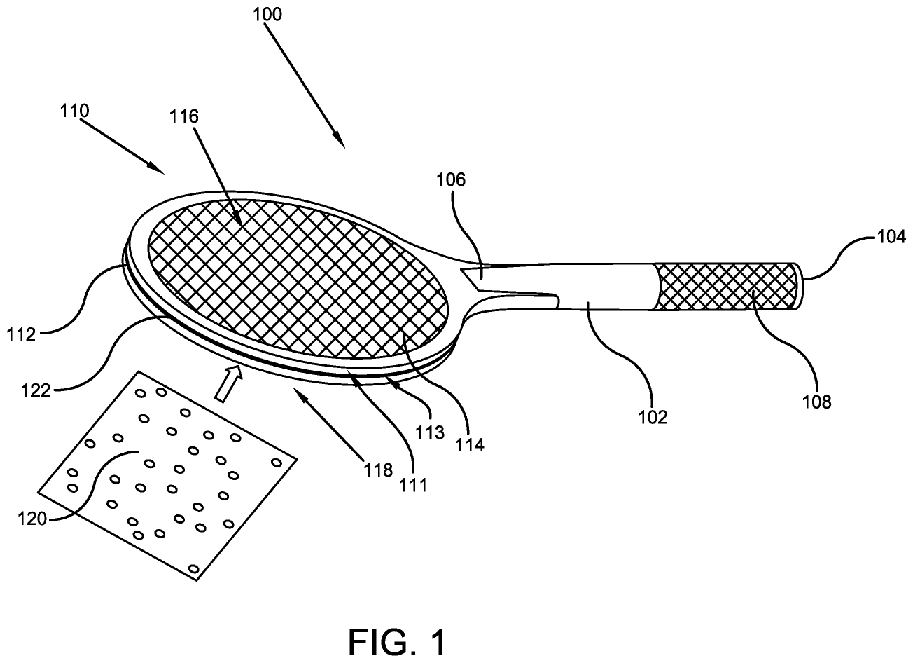

Referring initially to the drawings, FIG. 1 illustrates a perspective view of one potential embodiment of a glue trap fly swatter 100 of the present invention built in accordance with the disclosed architecture. The glue trap fly swatter 100 is designed to be used as a handheld capturing tool for catching mosquitoes, gnats, insects, and airborne pests from mid-air and/or from any surface. More specifically, the fly swatter 100 includes an elongated handle 102 that includes a proximal end 104 and a distal end 106. An ergonomic grip 108 is positioned at the proximal end 104 for comfortable gripping of the fly swatter 100 during use. An oval head 110 is integrally attached to the distal end 106 of the handle 102 and includes a peripheral boundary 112. The oval head 110 includes an oval opening 114 that is enclosed by the peripheral boundary 112 and the oval head 110 includes strings 116, 118. The first plurality of strings can be in a mesh form 116 and the second plurality of strings can be in a mesh form 118, disposed on opposing sides of the oval head 110.

The strings 116, 118 are removably-attached or hingedly-attached to the oval head 110 and are used for accommodating and mounting a double-sided glue trap 120 therebetween. The double-sided trap 120 is preferably yellow in color, which is used to attract small flying insects and includes a non-drying glue coating. The trap 120 is adapted to adhere a bug or insect thereto for trapping the insect in the flyswatter 100. Further, the glue trap 120 is non-poisonous and weatherproof. The double-sided glue trap 120 can be sized as per the dimensions of the oval opening 114 and can be slid through a slot 122 in the oval head 110 wherein a user slides a glue trap 120 through the slot 122. The glue trap 120 can then be sandwiched between the strings 116, 118. Alternatively, the oval head 110 can be selectively separated into two sections 111, 113 to enable the glue trap 120 to be placed therebetween. For replacing after use, the user can slide off the trap 120 from the opening 114 through the slot 122, or from the separated sections 111, 113. Alternatively, the strings 116, 118 are removably-attached to the oval head 110 and can be removed to replace the glue trap 120. The gnat trap flyswatter 100 can be used for fruit flies, fungus gnats, thrips, midges, locust, flies, whiteflies, aphids, moths and many more flying and non-flying insects.

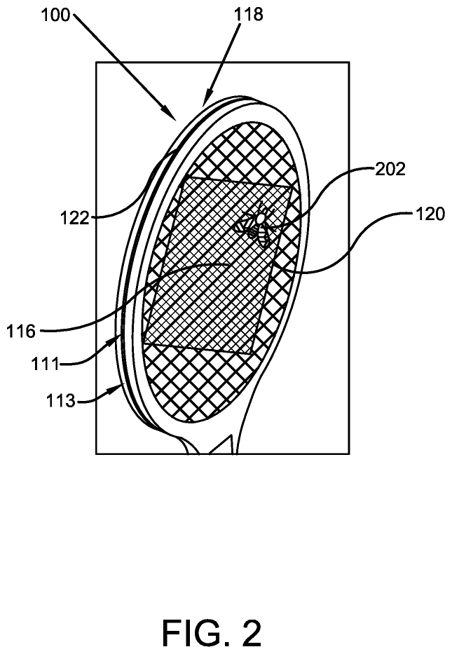

FIG. 2 illustrates a perspective view of the one potential embodiment of a glue trap fly swatter 100 of the present invention with integrated glue trap 120 in accordance with the disclosed architecture. To use the fly swatter 100 to kill various types of flies and insects, the double-sided glue trap 120 is integrated in the head opening 114 and is supported by the strings 116, 118 on opposing sides of the glue trap 120. In the present embodiment, the glue trap 120 can be slid into the opening either through the slot 122 or by opening the sections 111, 113 and separating of the strings 116, 118 from the frame. The strings 116, 118 can be of a lightweight metal and can be in the form of a mesh with gaps or openings such that flies and insects can adhere to the glue trap 120 easily. The strings 116, 118 are designed to provide adequate support to the integrated glue trap 120 while providing space and exposure for the flies and insects shown as exemplary fly 202 to adhere to the glue sheet 120. When the glue trap sheet 120 is covered with insects and flies shown as exemplary fly 202, then, the trap sheet 120 can be replaced by a new trap sheet. It is to be appreciated that the trap sheet 120 can be perforated (refer to FIG. 1) for ease of movement of the fly swatter 100 through the air.

It should be appreciated that the flyswatter 100 of the present invention neither uses any electrical components nor requires a user to swat a fly or insect, for example squash a fly between a flyswatter and another rigid surface, as used in conventional flyswatters. A user can simply wave the flyswatter 100 in the air at one or more flies or insects to effectively capture them on the integrated glue trap 120.

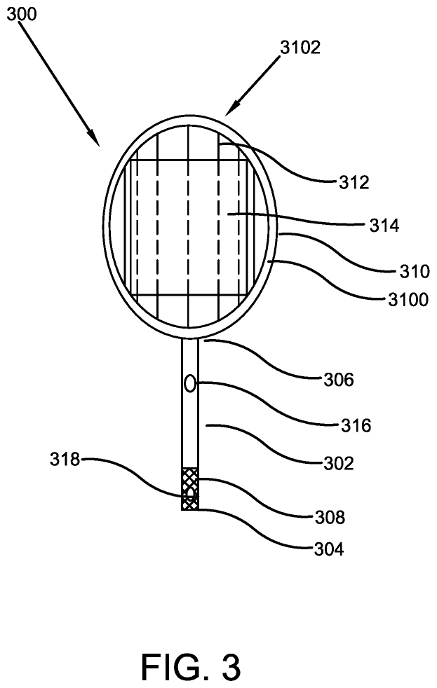

FIG. 3 illustrates a perspective view of another potential embodiment of the glue trap fly swatter 100 of the present invention in accordance with the disclosed architecture. In the present embodiment, the flyswatter 300 includes a tubular handle 302 having a proximal end 304 and a distal end 306. An ergonomic grip 308 is positioned on the proximal end 304 for gripping the flyswatter 100 by a user. An oval frame 310 is integrally-attached to the handle 302 at the distal end 306 and includes a first side 3100 and a second side 3102. A first frame of flexible strings 312 is removably-positioned on the first side 3100 and similarly a symmetrical opposing second frame of flexible strings (not shown) is removably positioned on the second side 3102 of the oval frame 310. The oval frame 310 includes an integrated double-sided glue trap 314 between the first frame 312 and the symmetrical opposing frame such that the insects and flies can adhere to the glue trap 314 when the flyswatter 100 is waved in the air, mounted upright, or is placed on a surface. The spaces between the individual strings expose the glue trap 314 to the insects and flies, thereby allowing them to adhere to the trap 314.

For replacing the glue trap 314 when the trap 314 is covered by the insects and flies, a push button 316 is pressed that releases the first frame of strings 312 from the first side 3100. The user can then replace the glue trap 314 with a new trap and then can manually press the strings onto the first side 3100 to attach the strings to the first side 3100 for supporting the new glue trap. A mounting hole 318 can be used for mounting the flyswatter 300 on a wall hook.

It should be appreciated that the first frame 312 can be removed manually by the user without using the push button 316. Also, the symmetrical frame positioned on the second side 3102 of the oval frame 310 can be manually removed by the user.

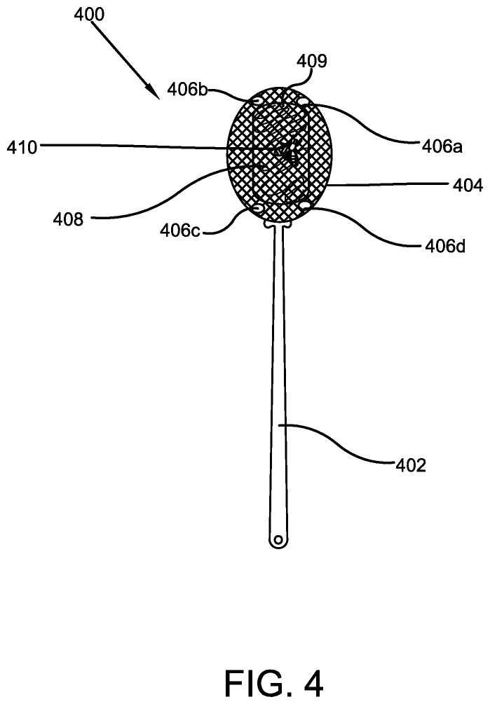

FIG. 4 illustrates a perspective view of yet another potential embodiment of the glue trap fly swatter 400 of the present invention in accordance with the disclosed architecture. As shown, the flyswatter 400 is a one-piece structure having a flexible handle 402 and an oval-shaped swatting head 404. The swatting head 404 can be a mesh pattern or perforated configuration to enable air to pass therethrough. On both sides of the swatting head 404, a double-sided glue trap 408 can be attached using fasteners 406a, 406b, 406c, 406d. The double-sided glue trap 408 is removably attached and can be removed by removing the fasteners 406a, 406b, 406c, 406d. The glue trap 408 can be a mesh pattern or perforated configuration with openings 409. The openings 409 enable the fly swatter 400 to be moved through the air with less resistance as air can pass through the openings 409. The glue trap 408 is used for adhering one or more insects and flies thereto, as shown as an exemplary fly 410.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “glue trap fly swatter”, “fly swatter”, “flyswatter” and “gnat trap flyswatter”, are interchangeable and refer to the glue trap fly swatter 100, 300, 400 of the present invention.

Notwithstanding the forgoing, the glue trap fly swatter 100, 300, 400 of the present invention can be of any suitable size and configuration as is known in the art without affecting the overall concept of the invention, provided that it accomplishes the above-stated objectives. One of ordinary skill in the art will appreciate that the size, configuration, and material of the glue trap fly swatter 100, 300, 400 as shown in the FIGS. are for illustrative purposes only, and that many other sizes and shapes of the glue trap fly swatter 100, 300, 400 are well within the scope of the present disclosure. Although the dimensions of the glue trap fly swatter 100, 300, 400 are important design parameters for user convenience, the glue trap fly swatter 100, 300, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A glue trap fly swatter comprising:
an elongated handle having a proximal end and a distal end;
an ergonomic grip positioned at said proximal end for gripping said glue trap fly swatter;
an oval head integrally attached to said distal end of said elongated handle, wherein said oval head comprises a peripheral frame boundary defining an opening, and further wherein said peripheral frame boundary comprises a first set of strings and a second set of strings having a space therebetween; and
a double-sided glue trap mountable in said space, wherein said double-sided glue trap comprises a non-drying glue coating, and further wherein said double-sided glue trap is replaceable.

2. The glue trap fly swatter of claim 1 further comprising a mesh configuration formed by said first set of strings and said second set of strings.

3. The glue trap fly swatter of claim 2, wherein said first set of strings is removably attached to said oval head.

4. The glue trap fly swatter of claim 1, wherein said peripheral frame boundary comprises a slot for inserting said double-sided glue trap therethrough.

5. The glue trap fly swatter of claim 2, wherein said peripheral frame boundary comprises a first section selectively attached a second section for inserting said double-sided glue trap therein.

6. The glue trap fly swatter of claim 1, wherein said double-sided glue trap is perforated.

7. A glue trap fly swatter comprising:
an elongated handle having a proximal end and a distal end;
an ergonomic grip positioned at said proximal end for gripping said glue trap fly swatter;
an oval head integrally attached to said distal end of said elongated handle, wherein said oval head comprises a peripheral frame boundary defining an opening;
a first set of strings;
a second set of strings, wherein a space exists between the first set of strings and the second set of strings; and
a double-sided glue trap mountable in said space, wherein said double-sided glue trap is replaceable.

8. The glue trap fly swatter of claim 7 further comprising a mesh configuration formed by said first set of strings and said second set of strings.

9. The glue trap fly swatter of claim 8, wherein said first set of strings is removably attached to said oval head.

10. The glue trap fly swatter of claim 9, wherein said double-sided glue trap is perforated.

11. The glue trap fly swatter of claim 10, wherein said double-sided glue trap comprises a non-drying glue coating.

12. The glue trap fly swatter of claim 8, wherein said peripheral frame boundary comprises a slot for inserting said double-sided glue trap therethrough.

13. The glue trap fly swatter of claim 8, wherein each of said first set of strings and said second set of strings are comprised of a metal.

14. A glue trap fly swatter comprising:
an elongated handle for gripping said glue trap fly swatter;
a swatting head integrally attached to said elongated handle;
a first glue trap mounted to a first side of said swatting head; and
a second glue trap mounted to a second side of said swatting head, wherein each of said first glue trap and said second glue trap are replaceable.

15. The glue trap fly swatter of claim 14, wherein said swatting head is perforated.

16. The glue trap fly swatter of claim 15, wherein each of said first glue trap and said second glue trap is perforated.

17. The glue trap fly swatter of claim 14, wherein each of said first glue trap and said second glue trap are double-sided.

18. The glue trap fly swatter of claim 17, wherein each of the first glue trap and the second glue trap are yellow in color.

19. The glue trap fly swatter of claim 17, wherein each of the first glue trap and the second glue trap comprise a non-drying glue coating.

20. The glue trap fly swatter of claim 14, wherein said swatting head comprises a plurality of fasteners thereon for selectively mounting said first glue trap and said second glue trap.
